(19) United States
(12) Patent Application Publication
(10) Pub. No.: US 2004/0242257 A1
(43) Pub. Date: Dec. 2, 2004

(54) Pilot channel power autotuning

(76) Inventors: Kimmo Valkealahti, Helsinki (FI); Albert Hoglund, Helsinki (FI); Jyrki Parkkinen, Helsinki (FI); Jaana Laiho, Veikkola (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/491,499

(22) PCT Filed: Oct. 22, 2001
(86) PCT No.: PCT/EP01/12192

(51) Int. Cl. H04Q 7/20

(52) U.S. Cl. 455/522; 455/69; 455/68

(57) ABSTRACT

The invention proposes a method for controlling a network, comprising at least one cell served by a first type network device, wherein the first type network device is adapted to serve second type network devices, wherein the emission of the first type network device includes an individual pilot signal to the second type network devices, and the emission of the second type network devices includes measurement reports including information on the status and the situation of the respective device, the method comprising the steps of

detecting information (S1) in the second type network devices, said information indicating the power level of the pilot signals received, collecting (S2) measurement reports (MR) from the second type network devices, said measurement reports (MR) including the pilot power information gained in the detecting step (S1),

evaluating (S3) the pilot signal power coverage in that cell on the basis of a pre-given number of measurement reports (MR),

automatically adjusting (S4) the pilot signal power coverage in that cell on the basis of the result of the evaluation step. The invention proposes also a device for controlling a network.

### FIELD OF THE INVENTION

The present invention relates to a method and a device for controlling the pilot signal power of a mobile telecommunication system.

### BACKGROUND OF THE INVENTION

In mobile communication technologies like, e.g. UMTS (Universal Mobile Telecommunication System) or GSM (Global System for Mobile Telecommunication), base stations serve a limited number of mobile users according to the current location of the users. As long as a user is in a base station cell area, he can obtain mobile services from that base station. The overall performance and the quality of the service depends—among others—on propagation conditions, cell type, cell size, load distribution and on the power level of the various signal transmissions, particularly of the pilot signal provided by each base station.

The pilot signal transmitted by each base station carries a bit sequence or code known by the mobile stations. The bit sequence can be base station and sector dependent. The power level of the pilot signal received by the mobiles is used by the mobile stations to measure the relative distance between different base stations that could be used for communication. Thus, the power level of the pilot signal of a base station determines how far a mobile can “hear” the base station; i.e. the power of the pilot signal is an indication to the mobile station of its ability to successfully use the signal from that base station which is transmitting that pilot signal.

In Code Division Multiple Access networks (CDMA) the pilot signal is only modulated by the pseudo-noise (PN) spreading codes which facilitates the process of generating a time synchronized replica at the receiver of the spreading sequences used at the transmitter to modulate the synchronisation, paging and traffic channels transmitted from that base station. The pilot channel provides the coherent reference signal needed to demodulate the coherent binary phase shift keying modulation used on the forward link Binary Phase Shift Keying (BPSK). The pilot signal provides further important functions, and to do so reliably, the power level at which the pilot signal is transmitted is typically higher than the power used on any other channel. Thus, a pilot signal power level of 2 watts is not unusual. With the total forward-link power output of the 8 watts, the pilot power is usually on the order of 25% of the total forward link power. Hence, the power of the pilot signal has a strong impact on the performance and on the overall costs of the network.

In Wideband Code Division Multiple Access network (WCDMA-Systems) the cell selection, re-selection and the selection of the active set of cells which are used for communication is based on the relative strength of the received Common Pilot Channel (CPICH) signal power (CPICH Ec/Io, wherein Ec/Io is chip energy to total interference spectral density) from different cells. Thus, the borders of a cell are determined by the relative strength of the pilot signal received from different cells. Hence, the power level of the pilot signal determines the pilot power coverage, i.e. the area of the cell in which the pilot signal is sufficiently powered to be properly decoded by the mobiles.

The optimal setting of cell-based pilot signal power values vary with propagation conditions and cell type, cell size, low distribution etc. Depending on these parameters, the setting of the pilot signal power may be too low in some cells under certain circumstances, thus risking lower performance. Under certain conditions in some other cells also a too large proportion of the power resources might be used for the pilot channel, sufficient coverage of pilot signal could be ensured in these cases with lower levels, i.e. with lower overall costs. The too high setting may be more probable due to the fact that operators wish to achieve proper CPICH coverage

### SUMMARY OF THE INVENTION

Therefore, the object underlying the invention resides in providing a method and a device for controlling a network wherein the power level of the pilot signal of each cell is automatically adjusted to a preferred optimum setting depending on the requirements set by the operator.

This object is solved by a method for controlling a network, comprising at least one cell served by a first type network device, wherein the first type network device is adapted to serve second type network devices, wherein the emission of the first type network device includes an individual pilot signal to the second type network devices, and the emission of the second type network devices includes measurement reports including information on the status and the situation of the device,

the method comprising the steps of

detecting information (S1) in the second type network devices, said information indicating the power level of the pilot signals received, collecting (S2) measurement reports (MR) from the second type network devices, said measurement reports (MR) including the pilot power information gained in the detecting step (S1), evaluating (S3) the pilot signal power coverage (CPICH-Coverage) in that cell on the basis of the pre-given number of measurement reports (MR), automatically adjusting (S4) the pilot signal power coverage in that cell on the basis of the result of the evaluation step (S3). Alternatively, the above object is solved by a network control device wherein the quality indicator is related to the costs of operation. The costs can be a combination of operator preferred issues like cost of transmit power, cost of quality experienced by users, cost of provided CPICH coverage etc.

Thus, by automatically adjusting the power level of the pilot signal it is possible to assure sufficient pilot power coverage while minimizing the usage of the resources of the respective base station. The assurance of sufficient pilot signal power should mainly take place during high cell load. The autotuning of the pilot signal power increases the service probability and throughput in the network, it is the basis for homogeneously loaded cells and for avoiding more effectively the overload of specific cells. Further, autotuning the pilot signal power enables the network to react automatically on changes of the traffic distribution, i.e. the network can automatically respond to load distribution varying over a short time. Temporary “hotspots” (e.g. sport events or other open air events) may be better served.

Automatic adjustment of the pilot signal power is particularly important in mobile phone networks in which the power of other downlink channels are set relative to the pilot signal power. When reducing the pilot signal power in such a network the other powers get automatically reduced and thus the net effect is rather significant. The power saved through autotuning can be utilized to improve capacity.

The automatic adjustment of the power level of the pilot signal is based on the information detected in the second type network devices. This information is communicated in the measurement reports of the second type network devices. The power level of the pilot signal is preferably adjusted such that the pilot power coverage in the cell is within a given range or above a pre-given target coverage to ensure good performance of the cell. Preferably the measurement reports used can be for example ‘call set up measurement Ec/Io level reports,’ Ec/Io being the ratio of the received energy per PN chip to the total transmitted power spectral density. It is preferred to keep the pilot signal power of a cell up to a level on which a specified share of the received CPICH Ec/Io levels exceed the required threshold value for providing sufficient pilot signal power at the cell edge detected in said detecting step (S1) includes handover measurement information. Furthermore, the measurement reports may be obtained by handover event triggered intra-frequency measurement reports, periodic measurements requested by the network, or they may be collected during the call setup phase, or by any combination of the above procedures.

The network in which the method is applied is a Code Division Multiple Access Network (CDMA), alternatively it may be a Wideband Code Division Multiple Access Network (WCDMA). In the WCDMA the pilot signal is the so-called Common Pilot Channel CPICH. In an UMTS-Terrestrial Radio Access (so-called UTRA), there are two types of common pilot channels CPICH, a primary CPICH and a secondary CPICH. An important area for the primary CPICH in WCDMA is the measurements for the handover and the cell selection/re-selection. The use of the primary CPICH reception level at the second type network devices for handover measurements has the consequence that by adjusting the primary CPICH power level, the cell load can be balanced between difference cells. Reducing the primary CPICH power level causes part of the second type network devices to handover to other cells while increasing the primary CPICH power level invites more second type network devices to handover to the cell of that pilot signal channel as well as to make there initial access to the network in that cell.

Thus, ‘handover event triggered intra-frequency measurement reports’ are preferably used in UMTS, since they indicate information on the power level of the pilot signal on the cell edge. These measurement reports from the second type network devices are collected and subject to a statistic routine by which the power level of the pilot signal is automatically adjusted. Reducing the pilot power level causes part of the second type network devices to handover to other cells while increasing the pilot power level invites more second type terminal devices to handover to the specific cells in which the pilot power was increased. Hence, the method and the device of the invention not only assure sufficient pilot power coverage but are also a means to balance cell load and ease load in congested cells.

An alternative form of measurement reports are periodic measurement reports requested by the base station or radio network controller.

The method according to the invention may be performed for a cluster of cells C1, C2, C3 . . . These cells are clustered according to some criteria, for instance, adjacency, similarity in load or operating point. Clustering is not a strict requirement but it improves the result of the algorithm. The cell clusters can be determined with some applicable clustering method. In such a cell cluster, the measurement reports from the second type network devices of all cells are collected, preferably the CPICH-Ec/Io levels received at the second type network devices are used. Then, the pilot power information is evaluated, whereby the number of CPICH-Ec/Io values exceeding the respective threshold value are calculated. If the calculation indicates significantly higher pilot signal power than the threshold value, the pilot signal power of all cells in the cluster are decreased. If the calculation shows significantly lower pilot power, i.e. pilot power coverage, the power of the pilot signal will be increased in all cells of the cluster.

This adjustment of the pilot power coverage in a cell cluster may be carried out either uniformly per cluster or individually on a cell per cell basis. By this method, the usage of the power resources for the primary CPICH are minimized while coverage with sufficient power level for the primary common pilot channel is assured.

Preferably the automatic adjustment of the power of the pilot signal is performed on a per cluster basis. However, if the pilot signal power also called CPICH power of a single cell is too low based on a per-cell analysis, the CPICH-power in this cell may be individually increased. The threshold value of the CPICH power in an per-cell analysis can defer from that in a per-cluster analysis. Preferably, however, the ratio of the CPICH-power to the maximum transmission power of the first type network device must not defer too much from the average in the neighbouring cells to avoid unbalanced cell loading.

Preferably, the CPICH-power, e.g. the power level of the pilot signal or common pilot channel should not be decreased in a low load situation because a sudden increase in the load would deteriorate the received CPICH- power level and, like the respective CPICH-power coverage. Preferably the method according to the invention may be extended so that partial load balancing for the network is also performed. For this purpose, the downlink total transmission power of each cell is detected (Step 5), this information is collected and the pilot signal power in the adjusting step (S4) is made dependent not only on the detected and evaluated pilot power coverage (Step 3 and Step 4) but additionally on the detected and collected downlink load information (Step 5 and Step 6).

In this embodiment the CPICH-power level is automatically adjusted in such a way that the downlink total transmission power of adjacent cells are aimed similar. If the downlink total transmission power of a cell is significantly higher than that of its neighbours, this decreases the CPICH-power level which reduces the cell size, and the load will decrease with the number of connections. In the same way, a cell with significantly low downlink load increases its CPICH-power

To calculate the load, each cell may collect statistics of its total transmission power: The average of power, the variance of power, and the number of collected samples. To make the statistics commensurate among micro- and macro-cells, the collected samples should be divided with the maximum base station power or with the downlink target power. Moreover, it may beneficial to logarithmize the samples as their distribution is likely log-normal. At regular intervals, the cell asks its neighbour cells for the values of their respective power statistics. From the collected information, the cell can then calculate its load and categorize it as significantly lower than, not significantly different from, or significantly higher than the load in adjacent cells, and the CPICH-power level can be adjusted in the adjustment step (S4) as follows:

If the calculation indicates significantly high load, then the CPICH-power level of the cell is decreased; if the calculation indicates significantly low load, then the CPICH-power level of the cell is increased.

Other measurements that can be used to evaluate the loading in the cell include in DL number of connections and throughput (e.g. in kbit/s) and in UL total received power level, throughput and number of connections. If both pilot power coverage autotuning and partial load balancing are implemented in the cell, both operations can indicate conflicting adjustments of the CPICH-power level. For instance, when the CPICH-power coverage is lower than the coverage target value and if the load is higher than that in the neighbour cells, the former condition indicates to increase the CPICH-power whereas the latter indicates to decrease the CPICH-power of that cell. Thus, a decision about a preferred change must be made. The decision can also be that no adjustment of the CPICH-power level is performed. The decision can be made with the aid of a decision table which includes statistics of the CPICH-power coverage and statistics on the cell load and which associates a preferred target level for the CPICH power level.

Preferably, after each adjustment of the CPICH-power level, the change of the total costs realized by the automatic adjustment can be monitored, and the adjustment can be taken back if no decrease in the total costs is realized. Instead of the total costs other quality indicators can be used as the decision making parameter.

The pilot power level can be controlled with an optimization (e.g. gradient-descent) method to minimize a cost function. The cost function comprises load information and coverage information, and possibly other relevant information, which are weighted in a way that the operator sees appropriate.

### BRIEF DESCRIPTION OF THE DRAWINGS

The present invention will be more readily understood with reference to the accompanying drawings in which:

FIG. 1 shows a diagram wherein the inference of the pilot power level on the area of the base station cell is illustrated;

FIG. 2 shows a flow chart illustrating the procedure according to a first embodiment of the invention;

FIG. 3 shows a flow chart illustrating a procedure according to a second embodiment of the invention;

FIG. 4 shows a network system consisting of three cells wherein the procedure according to the second embodiment is applied.

### DETAILED DESCRIPTION OF PREFERRED EMBODIMENTS

In the following, preferred embodiments of the invention are described in more detail with reference to the accompanying drawings.

According to the first embodiment, a procedure is provided to automatically adjust the power level of the pilot signal of the cell of a mobile phone network to cover the cell with a sufficiently strong pilot signal such that the pilot signal can be properly decoded at the mobiles, so-called second type network devices. Thereby this automatic adjustment of the pilot signal power, the so-called pilot coverage or pilot power coverage, is adjusted to meet a pre-given target coverage with sufficient strong pilot signal throughout the cell.

The pilot signal is a signal provided by each base station, also called first type network device, which carries a bit sequence or code known by the mobile stations. The bit sequence can be base station and sector dependent. The received power level of the pilot signal is used by the mobile stations to measure the relative distance between different base stations that could be used for communication. Thus, the power level of the pilot signal of a base station determines how far a mobile can “hear” the base station signal, i.e. the power level of the pilot signal is an indication to the mobile stations of its ability to successfully use the signals from the base station transmitting that pilot signal. In a code division multiple access network (CDMA) the individual pilot signals are recognizable based on a specific offset of the short pilot PN sequences which have a period of exactly 215 chips. To provide these and other important functions reliably, the power level of the pilot signal is typically higher than the power used on any other channels. Usually, the pilot power is on the order of 25% of the total forward link power of a CDMA base station.

In Wideband Code Division Multiple Access networks (WCDMA) the pilot signal is the so-called Common Pilot Channel, CPICH, which is an unmodulated code channel that functions to aid the channel estimation for the dedicated channel and to provide the channel estimation reference for the common channels when they are not associated with the dedicated channels or not involved in adaptive antenna techniques. In the CDMA the cell selection, re-selection and the selection of the active set of cells which are used for communication, is based on the relative strength of the power level of the pilot signal received at the mobiles. Thus, the common pilot channel, CPICH should cover the cell with the pre-given power level, i.e. the so-called CPICH coverage should meet a pre-given target coverage in the cell which increases the traffic quality in the cell. By adjusting the pilot power coverage, the power resources of the total power can be minimized, and the adjustment or tuning of the pilot power coverage may be used to realize homogenously loaded cells, to avoid overload of specific cells and to cope easily with changes and traffic distribution. Usually, the CPICH power is on the order of 10% of the total forward link power of a WCDMA base station.

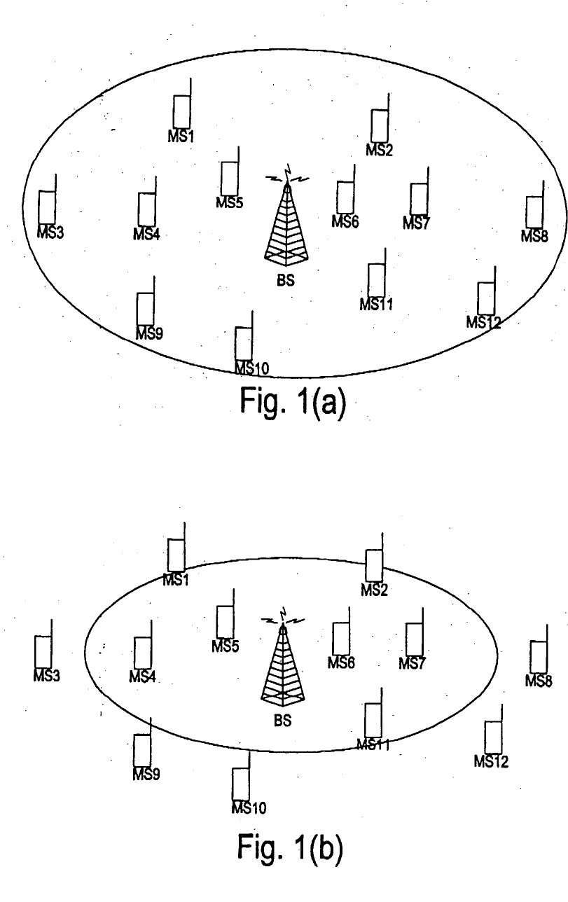

Hence, by changing the pilot power level in the cell covered by that pilot signal, the pilot power coverage of the respective cell can be changed. This is illustrated in FIG. 1(a) and 1(b). In FIG. 1(a) a high pilot power is set in the common pilot channel leading to a large area of the cell, allowing proper decoding of the pilot signal. In this cell, mobile stations MS1 to MS12 are served by the base station BS.

On the other hand, in FIG. 1(b) a lower pilot power level is set, leading to a smaller area of the cell. Thus, in FIG. 1(b) the numbers of served mobile stations is reduced. In detail, the mobile stations MS1, MS3, MS8, MS9, MS10 and MS12 are now outside the cell area and not served by the base station anymore. Hence, the total power transmission of that base station is decreased, the load on the base station is also decreased.

To automatically adjust the pilot signal power, mobile station measurements are used which indicate the actual pilot power received by the mobiles. The respective measurement reports of the mobile stations are then collected and evaluated on a statistic calculation routine, to give indication of the actual pilot power coverage in the cell.

In response to the evaluated pilot power coverage, the pilot power of the base station is automatically adjusted, i.e. autotuned, to establish a desired target coverage. Hence, a closed loop control of the power level of the pilot signal is realized, using the mobile station or user equipment measurement reports, i.e. the ‘call set-up measurement Ec/Io level reports’ (CPICH-Ec/Io level reports) or ‘handover event triggered intra-frequency measurement reports’ in UMTS to communicate the actual power level particularly at the edge of the cell, (wherein Ec/Io is the received energy per spreading code chip to the total transmitted power spectral density). The evaluation algorithms and the automatic adjustment step keep the pilot power of a cell preferably up to a level on which a specified share of the received CPICH Ec/Io levels exceed the corresponding threshold value. In addition to pilot power coverage assurance, the algorithms balance the cell load and ease load into congested cells.

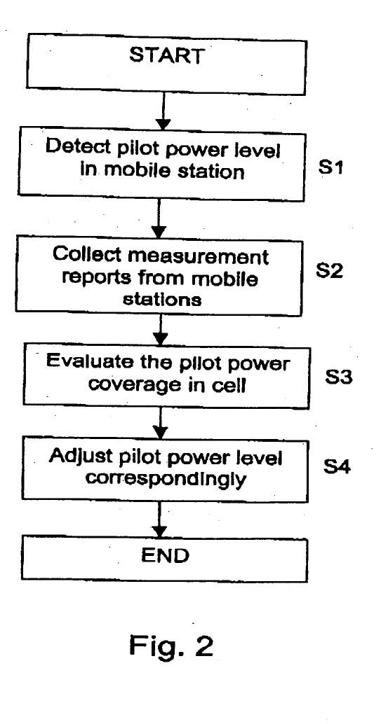

In the flow chart of FIG. 2, the procedure according to the first embodiment is illustrated.

In Step 1, information is detected in the mobiles which indicates the power level of the received pilot signal. In Step 2, measurement reports are collected from the mobile stations, which measurement reports MR include the pilot power information gained in Step 1. The measurement reports MR may be call setup measurement Ec/Io level reports, handover event triggered intra-frequency measurement reports in UMTS or periodic measurement reports requested by the base station or radio network controller.

In Step 3, a certain number of measurement reports MR are chosen and a control algorithm is applied to these selected measurement reports to evaluate the pilot power information of the measurement reports so as to evaluate the pilot signal power coverage in that cell.

Finally, in Step 4, the power level of the pilot signal is automatically adjusted on the basis of the result of Step 3. If the control algorithm indicates significantly higher pilot power coverage than the target coverage, the power level of the pilot signal will be automatically decreased, thus reducing the total transmission power of the base station. If however, the control algorithm indicates significantly lower pilot power coverage than the target coverage, the power level of the pilot power will be increased. The control algorithm will apply test statistics which use preferably from each mobile measurement report only the highest Ec/Io cell measurement in evaluating the actual coverage. The target pilot power coverage is the required proportion of the CPICH Ec/Io reports that exceed a given Ec/Io threshold. The number of CPICH Ec/Io measurements exceeding the Ec/Io threshold can be assumed binominally distributed. The assumption can be used to form standardized test statistic that describes the deviation of measured proportion, that is the coverage deviation from the pilot power target coverage. With the test statistic, the measured proportion can be categorized as significantly lower than, not significantly different from or significantly higher than the pilot power target coverage.

The automatic adjustment of the power level of the pilot signal may be on a per-cell basis or, if cell clusters are defined, on a per-cluster basis. If, however, the pilot power coverage of the single cell is too low based on a per-cell analysis, the power level of this cell may be increased individually. However, the automatic adjustment routine should not decrease the pilot power level in a low load situation, because a sudden increase in the load would deteriorate the power level received in the mobiles, and the like, the coverage. In improving of coverage with the control algorithm could take an overly long time to attend to quick load changes.

The pilot power coverage may not owe to low pilot signal power. In such cases an increase in the power level does not improve coverage. The increase is not needed and it may even be harmful to the performance. Thus, such situations should be detected and the increasing of the power level stopped.

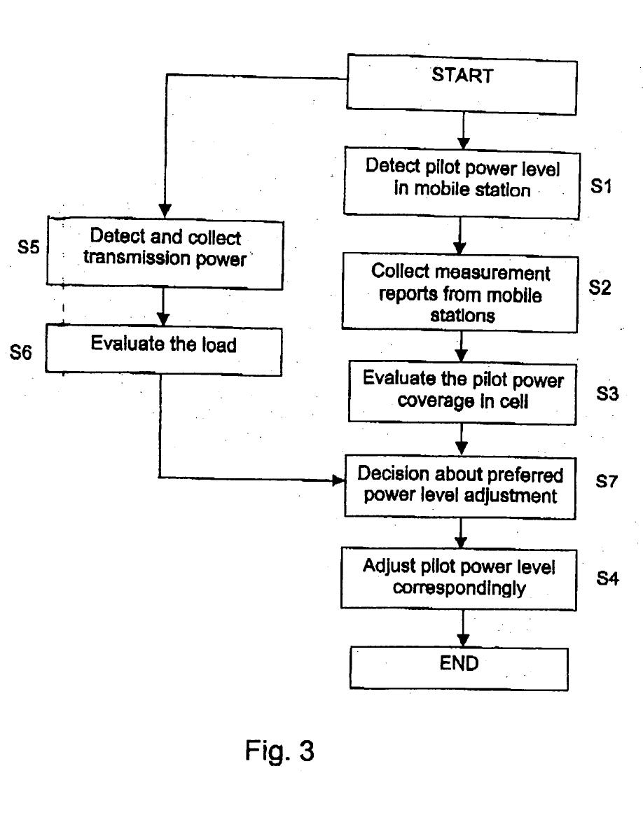

In the flow chart of FIG. 3, the procedure according to the second embodiment is illustrated.

The Steps 1, 2, 3 and 4 are identical with the Steps 1 to 4 of the first embodiment. However, in addition to the detection and evaluation of the pilot signal power and the pilot power coverage, the total transmission power of the cell is collected on a statistic basis, i.e. the average of power, the variance of power and the number of collected samples, this is realized in Step 5. It is necessary to divide the power samples with the maximum base station power or with the downlink target power in order to make the statistics commensurate among micro and macro-cells. From this power information, the load of the cell is evaluated in Step 6.

Additionally, at regular intervals the cell asks its neighbour cells for the values of their total transmission power statistics. The load evaluation, Step 6, may result in categorizing the load as significantly lower than, not significantly different from or significantly higher than the load in adjacent cells, and the pilot power level can then be automatically adjusted as follows:

If the test statistic indicates significantly high load, then decrease the pilot signal power of the cell; if however, the test statistic indicates significantly low load, then increase the pilot signal power of the respective cell.

When increasing the pilot signal power, the cell size increases, and this results in a load increase of the cell as connections move from adjacent cell to the increased cell. Hence, this embodiment of the invention integrates load balancing in the pilot coverage control.

If both operations are implemented in the cell in accordance with the second embodiment of the invention, they can indicate conflicting adjustments of the pilot signal power. For instance, when the pilot power coverage is lower than the target coverage, and if the load is higher than that in the neighbour cells, the former condition indicates an increase of the pilot power level, and the latter condition indicates a decrease in the pilot power. Thus, a decision about the preferred change must be made, this decision being made in step 7. In accordance with this decision, the pilot power level is then automatically adjusted in Step 4.

The decision may be made by asking a decision table which combines the pilot coverage statistic and the load statistic, resulting in a pre-given change in the pilot signal power. The respective table is presented as table 1 in which markings +, 0 , − stand for significantly higher, not significantly different and significantly lower values than the respective target levels. Table 1 shows that a significant load statistic takes precedence over the coverage statistic. The operator may choose differently, however.

TABLE 1

| Coverage statistic | Load statistic | Change in the CPICH power |
|---|---|---|
| − | − | increase |
| 0 | − | increase |
| + | − | increase |
| − | 0 | increase |
| 0 | 0 | no change |
| + | 0 | decrease |
| − | + | decrease |
| 0 | + | decrease |
| + | + | decrease |

After a change in the pilot power level has been made, it can be checked that a decrease in total operation costs really happened, otherwise the change can be taken back. The total operation costs and its components may be used to monitor the autotuning of the pilot power level. The costs may be calculated as a value of standardized test statistic, multiplied with with a cost coefficient. Alternatively, the costs may be calculated as a percentage of quality indicator exceeding the allowed level multiplied with the cost coefficient. The operator can set the costs and allowed levels according to his preferences. The quality indicators can e.g. be assumed to follow a binominal probability distribution and the standardized test statistic can describe the deviation of the number from a particular allowance level. This algorithm is preferably implemented into the network management system with the data collection in radio network controller. Possibly the algorithm could also run purely in the radio network controller in particular if fast congestion relief is targeted.

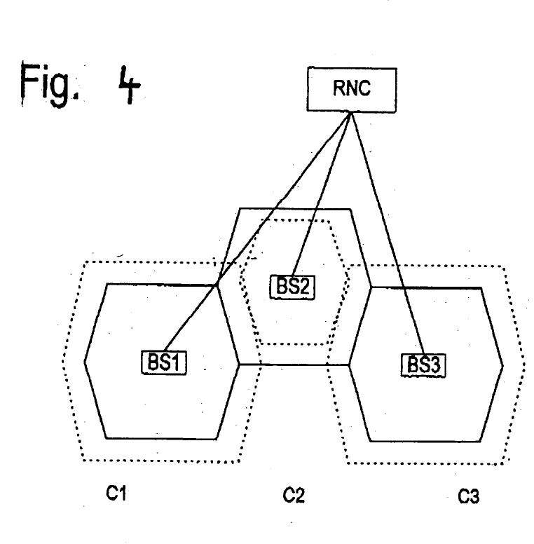

FIG. 4 illustrates a network containing three base stations BS1 to BS3 which serve three cells C1 to C3, respectively. The areas of the cells are idealized as hexagons. The cell borders before performing any automatic pilot power changes are indicated by a continuous line. The base stations are controlled (in this example) by a radio network controller RNC.

Now, it is assumed that cell C2 has a heavy load for example due to a sports event in its area. Thus, the load situations in the cell 2 is checked and also in the neighbouring cells C1 and C3, preferably by RNC. In this case, the RNC detects that the load on the cells C1 and C3 is comparatively small, whereas the load on the cell C2 is large. Hence, the pilot power level in cell C2 is reduced and the pilot power levels in cells C1 and C3 can be increased. The resulting areas of the cells are indicated by dotted lines. Hence, the cells C1 and C3 can serve mobile stations which had to be served in cell C2 before the pilot power change. In this way, more distributed load in the network is achieved, cell congestion can be avoided. The network can automatically respond to load distribution varying over a short time. Temporary “hot spots” (e.g. sport events) are better served.

The invention is not limited to the embodiments described above. Various amendments and modifications within the scope of the appended claims are possible.

For example, the control algorithms can be modified, the history of load in the cell can be taken into account that is, in case large changes occur in the load in comparison to the average load, the pilot power level can be changed correspondingly.

The RNC as a network control device is only an example. For example, the network control element in which the above automatic controlling function operates, may be a CSCCall State Control Function (CSCF) or an Network Management System (NMS) or another suitable device.

The method according to the invention is particularly designed for WCDMA, but it could be considered also for CDMA or GSM or any other network operating a plurality of mobile stations.

1-51. (Cancelled)

52. A method for controlling a network, comprising at least one cell served by a first type network device, wherein said first type network device is adapted to serve second type network devices, wherein the emission of said first type network device includes an individual pilot signal to said second type network devices, and the emission of said second type network devices includes measurement reports including information on the status and the situation of the respective device,
said method comprising the steps of
detecting information (S1) in said second type network devices, said information indicating the power level of the pilot signals received,
collecting (S2) measurement reports (MR) from said second type network devices, said measurement reports (MR) including said pilot power information gained in said detecting step (S1),
evaluating (S3) the pilot signal power coverage in that cell on the basis of a pre-given number of measurement reports (MR),
automatically adjusting (S4) the pilot signal power coverage in that cell on the basis of the result of said evaluation step, and
monitoring a change of a quality indicator realized by the automatic adjustment step of the power level of the pilot signal, and taking back the automatic adjustment of the power level if the monitored change leads to no decrease in total operation costs.

53. The method according to claim 52,
wherein said adjusting step (S4) adjusts the power of said pilot-signal such that the pilot signal power coverage in that cell is within or above a pre-given target coverage.

54. The method according to claim 52,
wherein said network is a Code Division Multiple Access Network (CDMA).

55. The method according to claim 52,
wherein said network is a Wideband Code Division Multiple Access Network (WCDMA), and said pilot signal is a primary Common Pilot Channel (PCICH or P-CPICH).

56. The method according to claim 52,
wherein said information detected in the detecting step (S1) indicates the following ratio:
CPICH-Ec/Io
wherein
Ec=average energy per spreading code chip for the pilot signal
Io=total received power density including signal and interference,
wherein the measurement reports including this information are CPICH-E_{c}/I₀ level reports emitted from the second type network devices.

57. The method according to claim 52,
wherein the power level of said pilot signal is used in said second type network devices to initiate handover from one cell to another cell, and wherein said information detected in said detecting step (S1) includes handover measurement information.

58. The method according to claim 57,
wherein said measurement reports collected in said collecting step (S2) are handover event triggered intra-frequency measurement reports.

59. The method according to claim 57,
wherein said measurement reports collected in said collecting step (S2) are periodic measurements requested by the network.

60. The method according to claim 57,
wherein said measurement reports collected in said collecting step (S2) are collected during call setup phase.

61. The method according to claim 57,
wherein said measurement reports collected in said collecting step (S2) are periodic handover event triggered intra-frequency measurement reports, collected during call setup phase.

62. The method according to claim 56,
wherein in said adjusting step (S1) the power of said pilot signal is adjusted such that a certain percentage of the CPICH-E_{c}/I₀ levels of the measurement reports exceed a required threshold value.

63. The method according to claim 62,
wherein said threshold value of CPICH-E_{c}/I₀ received at said second type network devices is sufficient for proper decoding said pilot signal in said second type network devices.

64. The method according to claim 52,
wherein the measurement reports are periodic Ec/Io measurement reports requested by the base station or the radio network controller.

65. The method according to claim 52,
wherein said first type network device is a base station.

66. The method according to claim 52,
wherein said second type network device is a mobile station.

67. The method according to claim 52,
further comprising the step of
detecting and collecting load information of the cell (S5) in a direction from said first type network device to said second type network devices and automatically adjusting the power of said pilot signal in said adjusting step (S4) on the basis of said collected measurement reports (MR) and on the basis of said detected load information.

68. The method according to claim 67,
further comprising the step of
detecting and collecting downlink load information of the cell (S5) in a direction from said first type network device to said second type network devices,
preventing a decrease of the pilot signal power in said adjusting step (S4) if the downlink load is below a load threshold value.

69. The method according to claim 67,
wherein the load information is the downlink or uplink number of connections and throughput.

70. The method according to claim 52,
detecting and collecting additional information about the downlink total transmission power or the uplink total received power of the cell and automatically adjusting the power of said pilot signal in said adjusting step (S4) on the basis of said additionally detected information.

71. The method according to claim 70,
wherein said additional information about the total transmission power of the cell includes the average transmission power, the variance of transmission power and the number of collected information samples.

72. The method according to claim 52,
wherein said method is performed for a cluster of cells (C1, C2, C3 . . . ), said measurement reports from said second type network devices of all cells are collected in said collecting step (S2), and the power of said pilot signal is automatically adjusted in the cells on the basis of said collected measurement reports.

73. The method according to claim 72,
wherein said measurement reports are collected from said second type network device on a per-cell basis,
and the power of said pilot signal is adjusted per-cell cluster or individually per-cell on the basis of said measurement reports of the individual cells.

74. The method according to claim 73,
wherein said measurement reports of said second type network devices are collected on a per-cell basis, and the power of said pilot signal is adjusted on a per-cell cluster basis, and whereby selected cells are additionally adjusted on a per-cell basis.

75. The method according to claim 73,
wherein measurement reports of one to several cells are combined.

76. The method according to claim 72,
further comprising the step of detecting and collecting (S5) information about the total transmission power of each cell,
statistically calculating load information (S6) for each cell and automatically adjusting the power of said pilot signal on the basis of said evaluation step (S4) and on the basis of the result of said load calculation step (S6).

77. The method according to claim 76,
wherein said load calculation step (S6) categorizes the load of a cell as significantly lower than, not significantly different from, or significantly higher than the load in adjacent cells, and wherein in said adjusting step (S4) the power of said pilot signal of that cell is automatically adjusted as follows:
if said load calculation step indicates a significantly high load, then the pilot power of this cell is decreased,
if said load calculation step indicates a significantly low load, then the pilot power is increased.

78. The method according to claim 77,
further comprising the step of deciding (S7) about a preferred adjustment of the pilot power in step (S4) if the pilot power information of said measurement reports (MR) and the load information indicate conflicting adjustments of the pilot power.

79. The method according to claim 78,
wherein the pilot power is controlled with an optimization method, e.g. gradient-descent method to minimize a given cost function.

80. The method according to claim 79,
wherein the cost function comprises load information and coverage information.

81. A network control device in a network comprising at least one cell served by a first type network device, wherein said first type network device is adapted to serve second type network devices, wherein the emission of said first type network device includes an individual pilot signal to said second type network devices, and the emission of said second type network devices includes measurement reports including information on the status and the situation of the device,
said network control device comprising
means for detecting information in said second type network devices, said information indicating the power level of the pilot signals received,
means for collecting measurement reports (MR) from the second type network devices, said measurement reports (MR) including the pilot power information gained by said detecting means,
means for evaluating the pilot signal power coverage in that cell on the basis of a pre-given number of measurement reports (MR),
means for automatically adjusting the pilot signal power coverage in that cell on the basis of the result gained by said evaluation means, and
means for monitoring the change of a quality indicator realized by the automatic adjustment of the power level of said pilot signal, wherein the automatic adjustment of the pilot power level is taken back if the monitored change leads to no decrease in total operation costs.

82. The network control device according to claim 81,
wherein said adjusting means adjusts the power of the pilot signal such that the pilot power coverage in that cell is above a pre-given target coverage.

83. The network control device according to claim 81,
wherein said network is a Code Division Multiple Access Network (CDMA).

84. The network control device according to claim 81,
wherein said network is a Wideband Code Division Multiple Access Network (WCDMA), and said pilot signal is a primary Common Pilot Channel (CPICH or P-CPICH).

85. The network control device according to claim 81,
wherein said information detected in said detecting means indicates the following ratio:
CPICH-Ec/Io
wherein
Ec=average energy per spreading code chip for the pilot signal
Io=total received power density including signal and interference,
wherein said measurement reports including this information are CPICH-E_{c}/I₀ level reports emitted from said second type network devices.

86. The network control device according to claim 81,
wherein the power level of said pilot signal is used in said second type network devices to initiate handover from one cell to another cell, and wherein said information detected in said detecting means includes handover measurement information.

87. The network control device according to claim 85,
wherein said measurement reports collected in said collecting means are ‘handover event triggered intra-frequency measurement reports’.

88. The network control device according to claim 85,
wherein said adjusting means adjusts the power of said pilot signal such that a certain percentage of the CPICH-E_{c}/I₀ levels of the measurement reports exceed a required threshold value.

89. The network control device according to claim 88,
wherein the threshold value of CPICH-E_{c}/I₀ received at said second type network devices is sufficient for proper decoding said pilot signal in said second type network devices.

90. The network control device according to claim 81,
wherein the measurement reports are periodic Ec/Io measurement reports requested by the base station or the radio network controller of the cell.

91. The network control device according to claim 81,
wherein said first type network device is a base station.

92. The network control device according to claim 81,
wherein said second type network device is a mobile station.

93. The network control device according to claim 81,
further comprising means for detecting and collecting load information of the cell in a direction from said first type network device to said second type network devices and automatically adjusting the power of said pilot signal by said adjusting means on the basis of said collected measurement reports (MR) and on the basis of said detected load information.

94. The network control device according to claim 93, further comprising
means for detecting and collecting a downlink load information of the cell in a direction from said first type network device to said second type network devices,
means for preventing a decrease of the pilot signal power if the downlink load is below a load threshold value.

95. The network control device according to claim 81,
means for detecting and collecting additional information about the downlink total transmission power or the uplink total received power of the cell and automatically adjusting the power of said pilot signal in said adjusting means on the basis of said additionally detected information.

96. The network control device according to claim 95,
wherein said additional information about the total transmission power of the cell includes the average power, the variance of power and the number of collected information samples.

97. The network control device according to claim 81,
wherein said network includes a cluster of cells (C1, C2, C3 . . . ), and said measurement reports from the second type network devices of all cells are collected in said collecting means and the power of said pilot signal is adjusted in the cells by said adjustment means on the basis of the collected measurement reports.

98. The network control device according to claim 97,
wherein said measurement reports are collected from said second type network device on a per-cell basis,
and the power of said pilot signal is adjusted per-cell cluster or individually per-cell on the basis of the measurement reports of the individual cells.

99. The network control device according to claim 98,
wherein said measurement reports of said second type network devices are collected on a per-cell basis, and the power of said pilot signal is adjusted on a per-cell cluster basis, and whereby selected cells are additionally adjusted on a per-cell basis.

100. The network control device according to claim 98,
further comprising means for detecting and collecting information about the total transmission power of each cell,
means for statistically calculating load information for each cell and automatically adjusting the power of said pilot signal by said adjustment means on the basis of said evaluation means and on the basis of said load calculation means.

101. The network control device according to claim 100,
said load calculation means categorizes the load of a cell as significantly lower than, not significantly different from, or significantly higher than the load in adjacent cells, and wherein in said adjusting means adjusts the power of the pilot signal of that cell automatically as follows:
if the load calculation indicates a significantly high load, then the pilot power of this cell is decreased,
if the load calculation indicates a significantly low load, then the pilot power is increased.

102. The network control device according to claim 101,
further comprising means for deciding about a preferred adjustment of the pilot power if the pilot power information of said measurement reports (MR) and said load information indicate conflicting adjustments of the pilot power.
